(19) United States
(12) Patent Application Publication
(10) Pub. No.: US 2003/0021478 A1
(43) Pub. Date: Jan. 30, 2003

(54) Image processing technology for identification of red eyes in image

(75) Inventor: Hiroki Yoshida, Osaka (JP)

Correspondence Address: Barry E. Bretschneider, Morrison & Foerster LLP, Suite 5500, 2000 Pennsylvania Avenue, N.W., Washington, DC, 20006-1888, US

(73) Assignee: Minolta Co., Ltd., Osaka-shi (JP)

(21) Appl. No.: 10/200,219

(22) Filed: Jul. 23, 2002

(30) Foreign Application Priority Data
Jul. 25, 2001 (JP) 2001-224628

(51) Int. Cl. G06K 9/46; G06K 9/00; G06K 9/40

(52) U.S. Cl. 382/195; 382/274; 382/167

(57) ABSTRACT

A computer program capable of appropriately identifying red-eye regions that are generated under various conditions, by causing a computer to function as an image processing apparatus having a characteristic region extracting unit that, based on characteristic levels of a target region encompassing an eye region of a target image, extracts from the target region as candidate red-eye regions multiple characteristic regions that include iris regions, and a red-eye region identification unit for identifying a red-eye region based on existence of contact between the iris regions and other characteristic regions, tone characteristics regarding characteristic levels of each characteristic region, and area information regarding areas of each characteristic region.

This application is based on Japanese Patent Application No. 2001-224628 filed in Japan on Jul. 25, 2001, the entire content of which is hereby incorporated by reference.

### BACKGROUND OF THE INVENTION

1. Field of the Invention

The present invention relates to a technology that identifies red eyes in an image.

2. Description of Related Art

When photography is carried out using a flash, the red-eye phenomenon in which the eyes of the person in the image appear as a glowing red or gold may take place. Because such red eyes are unnatural-looking, technologies have been proposed in the conventional art that correct the red eyes in the image to normal-appearing eyes by processing the obtained image via incorporation via a scanner of the photograph taken using a silver halide camera, or via the use of a digital camera for the photography.

For example, according to Japanese Laid-Open Patent Application H9-261580, a method is proposed in which the area that includes the pair of eyes and the center point thereof are designated by the operator, and correction is carried out by identifying areas in which the red-eye phenomenon is present (hereinafter ‘red-eye regions’) in the designated area.

However, because the characteristic levels such as hue and the ratio of the pupil in the image vary depending on the circumstances under which the photograph was taken or on individual differences among the objects, identification of red-eye regions has been difficult.

### OBJECT AND SUMMARY

An object of the present invention is to provide an improved computer program, etc. that resolves the various problems identified above.

Another object of the present invention is to provide a computer program, etc. capable of appropriately identifying red-eye regions that are generated under various conditions.

These various objects are attained by providing a computer program that causes a computer to function as an image processing apparatus having a characteristic region extracting unit that, based on the characteristic levels of a target region including an eye region of the target image, extracts from the target region as candidate red-eye regions multiple characteristic regions that include iris regions, and a red-eye region identification unit that identifies a red-eye region based on the existence of contact between the iris regions and other characteristic regions, the tone characteristics regarding the characteristic levels of each characteristic region, and the area information regarding each characteristic region.

The characteristic region extracting unit may extract characteristic regions based on the characteristic levels for at least two types of characteristics from among hue, saturation and brightness, which are calculated from the pixel values of the target region.

It is preferred that the characteristic regions include, in addition to iris regions, pupil regions and iris periphery regions. An iris region is a region having a hue and saturation that fall within prescribed ranges. A pupil region is a region having a saturation and brightness that fall within prescribed ranges. An iris periphery region is a region having the same hue range as an iris region and the same brightness range as a pupil region.

It is acceptable if, where an iris region is in contact with another characteristic region, the red-eye region identification unit establishes as a candidate red-eye region the iris region and the area comprising another characteristic region that is in contact with the iris region, but where an iris region is not in contact with any other characteristic regions, the iris region is excluded as a candidate red-eye region.

It is also acceptable if the red-eye region identification unit identifies one of the region established as candidate red-eye regions as a red-eye region based on the evaluation values calculated from the tone characteristics and the area information.

It is preferred that the area information consist of information regarding the area comprising the sum of the area of the iris region and the area of the other characteristic region that is in contact with the iris region.

The tone characteristics may include values calculated from the histograms regarding the characteristic levels for the iris region.

The tone characteristics may include values calculated from the positional continuity of the characteristic levels for the iris region.

The program described above may cause the computer to function as an image processing apparatus that further includes a skin color information obtaining unit that obtains skin color information from the colors of the pixels in the area surrounding the target region, and a characteristic region excluding unit that, where the color of the pixels included in a characteristic region matches the skin color information, excludes the characteristic region as a candidate red-eye region.

It is acceptable if the above program causes the computer to function as an image processing apparatus that includes a skin color retrieval region establishing unit that establishes the size of the surrounding area by which to obtain the skin color information, based on the size of the target image and the size of the target region.

These various objects are also attained by providing a program that causes a computer to function as an image processing apparatus that has a characteristic region extracting unit that, based on the characteristic levels regarding a target region including an eye region in the target image, extracts as candidate red-eye regions from the target region multiple characteristic regions that include iris regions, a contact relationship detecting unit that determines whether each iris region is in contact with another characteristic region, and a red-eye region identification unit that, where the contact relationship detecting unit determines that an iris region is in contact with another characteristic region, establishes the entire region comprising the iris region and the other characteristic region as a candidate red-eye region, and identifies one of such areas thus established as a red-eye region.

These various objects are also attained by providing an image processing apparatus that has a characteristic region extracting unit that, based on the characteristic levels regarding a target region including an eye region in the target image, extracts as candidate red-eye regions from the target region multiple characteristic regions that include iris regions, and a red-eye region identifying unit that, based on whether each iris region is in contact with another characteristic region, tone characteristics regarding the characteristic levels for each characteristic region, and the area information regarding each characteristic region, identifies a red-eye region.

These various objects are also attained by providing an image processing method comprising a step of extracting as candidate red-eye regions, based on the characteristic levels for a target region including an eye region in the target image, multiple characteristic regions that include iris regions from the target region, and a step of identifying a red-eye region based on whether each iris region is in contact with another characteristic region, tone characteristics regarding the characteristic levels for each characteristic region, and the area information regarding each characteristic region.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is an external view of an image processing apparatus pertaining to the present invention;

FIG. 2 is a block diagram showing the construction of the image processing apparatus;

FIG. 3 is a drawing showing the functional components of the image processing apparatus involved in the identification of a red-eye region;

FIG. 4 is a drawing showing the functional components of the characteristic region sorting unit;

FIG. 5 is a drawing showing the functional components of the red-eye region identification unit;

FIG. 6 is a drawing showing the sequence of the routine by which the image processing apparatus identifies a red-eye region;

FIG. 7 is a drawing showing the sequence of the routine by which the image processing apparatus identifies a red-eye region;

FIG. 8 is a drawing showing the sequence of the routine by which the image processing apparatus identifies a red-eye region;

FIG. 9 is a drawing showing the sequence of the routine by which the image processing apparatus identifies a red-eye region;

FIG. 10 is a drawing showing the display when a target region is designated;

FIG. 11 is a drawing showing an example of a brightness histogram;

FIG. 12 is a drawing to explain how a conversion curve for contrast correction may be obtained;

FIG. 13 is a drawing to explain how a conversion curve for contrast correction may be obtained;

FIG. 14 is a drawing showing an example of a conversion curve for contrast correction;

FIG. 15 is a drawing showing an example of extracted characteristic regions;

FIG. 16 is a drawing showing an example of extracted characteristic regions;

FIG. 17 is a drawing showing an example of a skin color retrieval region;

FIG. 18 is a drawing showing the sequence of the red-eye evaluation value parameters calculation routine in a first embodiment;

FIG. 19 is a drawing showing the sequence of the red-eye evaluation value parameters calculation routine in a second embodiment;

FIG. 20 is a drawing to explain how tone slope information may be obtained;

FIG. 21 is a drawing to explain how tone slope information may be obtained;

FIG. 22 is a drawing to explain how tone slope information may be obtained; and

FIG. 23 is a drawing to explain how tone slope information may be obtained.

### DETAILED DESCRIPTION OF THE PREFERRED EMBODIMENTS

Embodiments of the present invention are explained below with reference to the drawings.

1. First Embodiment

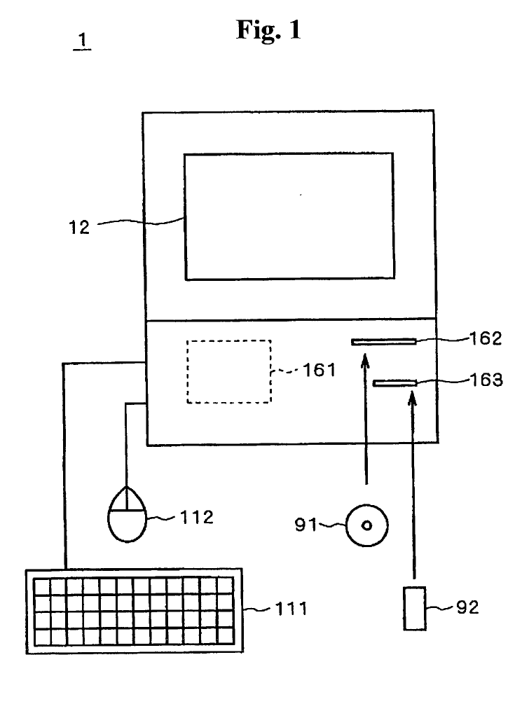

FIG. 1 is an external view of an image processing apparatus 1 pertaining to a first embodiment of the present invention. The image processing apparatus 1 is a computer that identifies red-eye regions in the target image and performs correction by executing a program. The image processing apparatus 1 includes a keyboard 111 and a mouse 112 that accept input from the user, and a display 12 that displays instruction menus for the user as well as obtained images or other information, as shown in FIG. 1.

The image processing apparatus 1 has a built-in fixed disk 161 that stores image data and other types of data, and a recording disk 91 that stores programs and a memory card 92 that stores image data can be placed in the reading device 162 and the card slot 163, respectively, as computer-readable recording media.

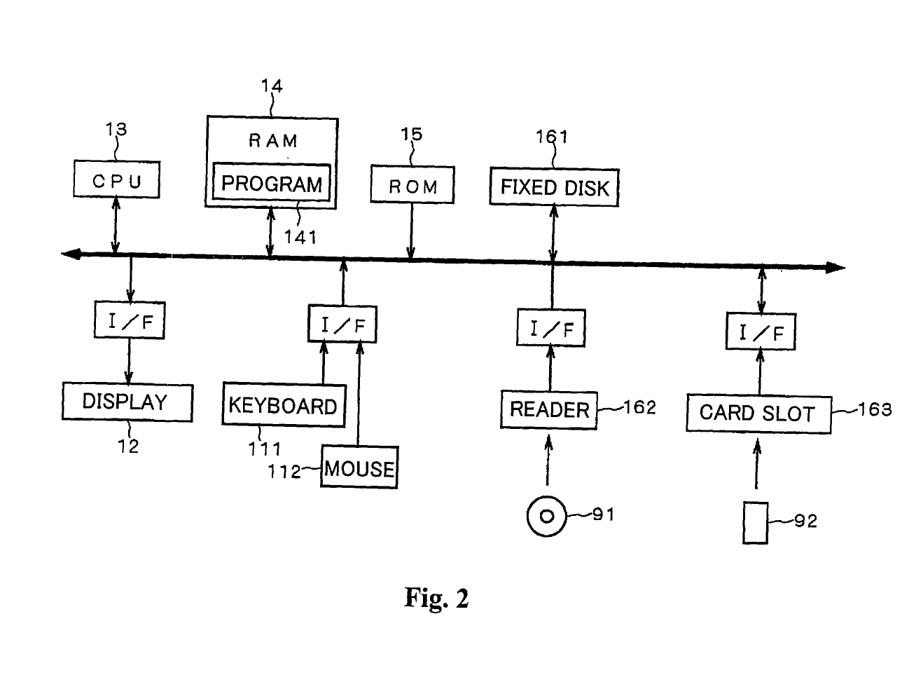

FIG. 2 is a block diagram showing the construction of the image processing apparatus 1. The image processing apparatus 1 has a general computer system construction in which a CPU 13, a RAM 14 and a ROM 15 are connected to a bus line. Also connected to the bus line are the display 12, the keyboard 111 and the mouse 112 that accept input from the user, the fixed disk 161 that stores data and programs, the reading device 162 that sends and receives information to and from the recording disk 91 (such as an optical disk, a magnetic disk or a magneto-optical disk), and the card slot 163 that sends and receives information to and from the memory card 92 via an interface (I/F), where appropriate.

The RAM 14, fixed disk 161, reading device 162 and card slot 163 can send and receive data to and from each other. Under the control of the CPU 13, various information and images stored in the RAM 14, fixed disk 161 or memory card 92 can be displayed on the display 12.

The program 141 shown in FIG. 2 is stored on the fixed disk 161 from the recording disk 91 via the recording device 162, and is forwarded from the fixed disk 161 to the RAM 14. It can be executed by the CPU 13. Where the image processing apparatus 1 includes computer communication means, the program 141 may be stored on the fixed disk 161 via computer communication such as over the Internet.

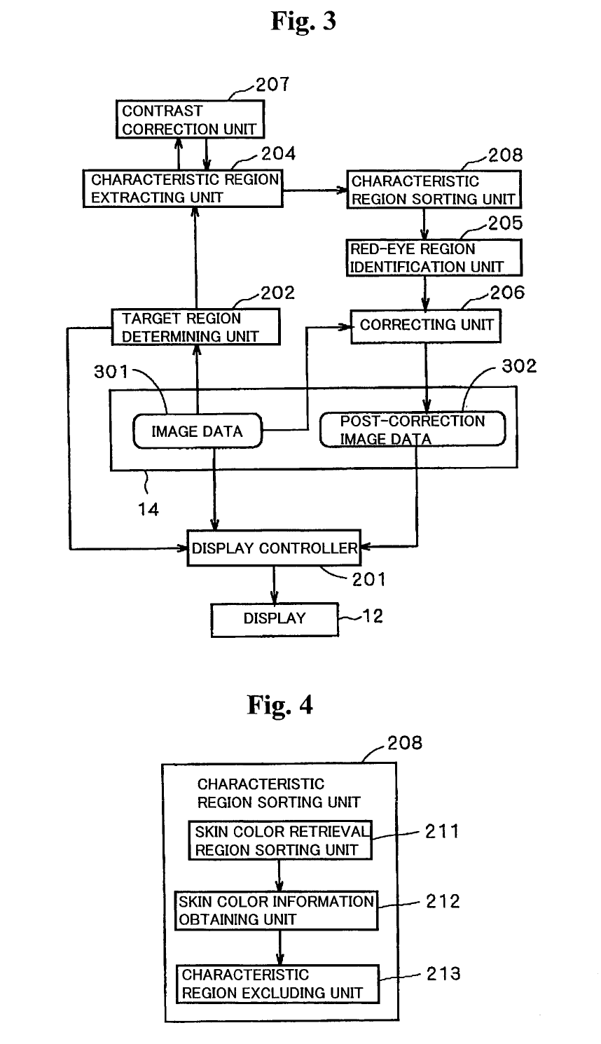

FIG. 3 is a drawing showing the functional components that are realized by the CPU 13 when it operates in accordance with the program 141 in the RAM 14, as well as other components. Among the components shown in FIG. 3, the display controller 201, the target region determining unit 202, the characteristic region extracting unit 204, the contrast correction unit 207, the characteristic region sorting unit 208, the red-eye region identification unit 205 and the correcting unit 206 are the functions realized by the CPU 13.

2 The display controller 201 controls the image display on the display 12 based on the image data. The target region determining unit 202 accepts from the user the designation, via the mouse 112, of a target region regarding which processing of the target image displayed based on the image data 301 is performed.

The characteristic region extracting unit 204 extracts multiple types of characteristic regions that may be candidate red-eye regions based on the characteristic levels of the target region. As characteristic levels, hue, saturation and brightness are used. The contrast correction unit 207 performs contrast correction for the target region of the target image and adjusts the brightness balance before the characteristic region extracting unit 204 extracts characteristic regions. The characteristic region sorting unit 208 sorts the characteristic regions by determining whether or not the hue of the pixels included in the extracted characteristic region matches the skin color hue. The red-eye region identification unit 205 identifies from among the multiple characteristic regions previously sorted a characteristic region that comprises a red-eye region. The correcting unit 206 performs correction to the identified red-eye region, and corrects the red-eye in the image to a normal-color eye. The post-correction image data is stored in the RAM 14 as corrected image data 302.

FIG. 4 is a block diagram showing the functional components of the characteristic region sorting unit 208. The characteristic region sorting unit 208 includes a skin color retrieval region establishing unit 211 that establishes the size of the region used to obtain the hue of the skin color (hereinafter the ‘skin color retrieval region’), a skin color information obtaining unit 212 that obtains as skin color information the hue of the skin color (hereinafter the ‘skin color hue’) from the pixels of the skin color retrieval region, and a characteristic region excluding unit 213 that excludes a characteristic region as a candidate red-eye region when the hue of the pixels included in the characteristic region matches the skin color hue.

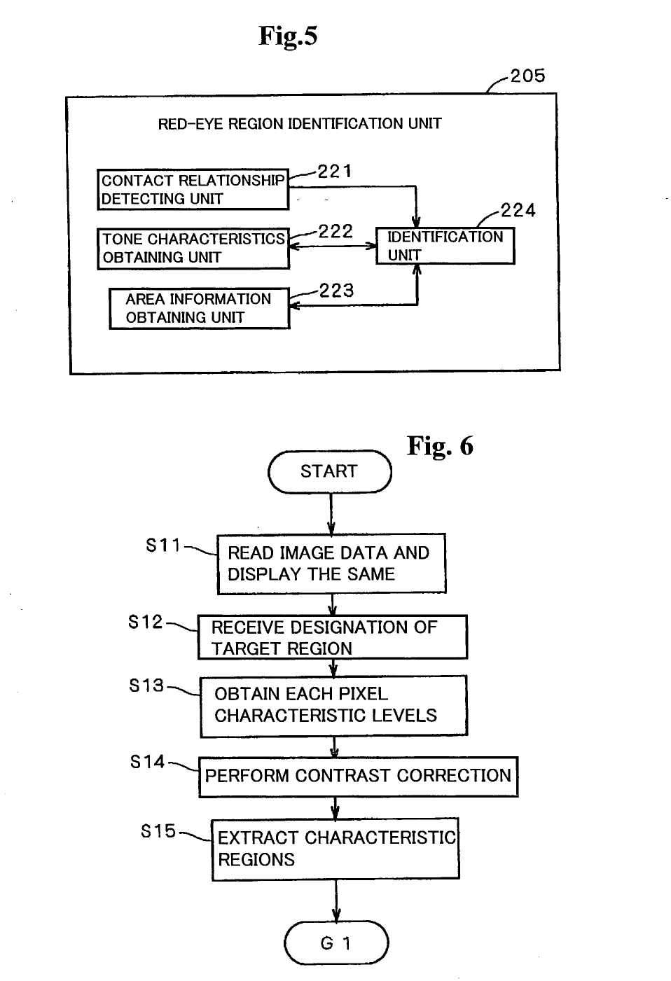

FIG. 5 is a block diagram showing the functional components of the red-eye region identification unit 205. The red-eye region identification unit 205 includes a contact relationship detecting unit 221 that detects the contact relationships among the characteristic regions sorted by the characteristic region sorting unit 208, a tone characteristics obtaining unit 222 that obtains the tone characteristics of the characteristic levels of each characteristic region, an area information obtaining unit 223 that obtains information regarding the area of each characteristic region, and an identification unit 224 that identifies a red-eye region based on such information. The details of the functions of the functional blocks shown in FIGS. 3 through 5 are provided below.

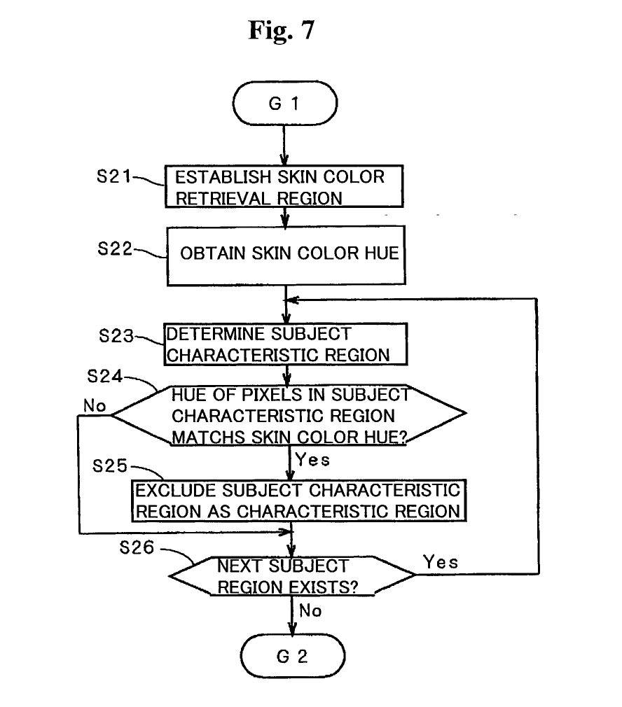

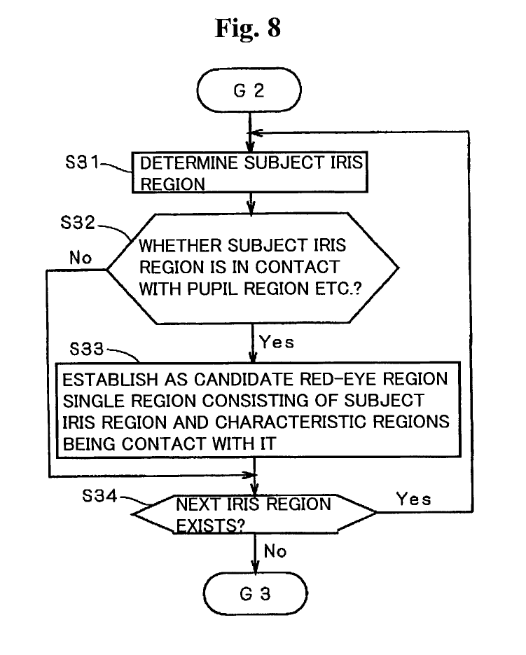

FIGS. 6 through 9 are drawings showing the sequence of the operations executed when the image processing apparatus 1 identifies a red-eye region and performs correction. Referring to FIGS. 3 through 9, the operations by which the image processing apparatus 1 identifies a red-eye region and performs correction will be explained below.

First, when the user selects as a target image desired image data from among the sets of image data 301 stored in the memory card 92 or on the fixed disk 161 using the keyboard 111 and the mouse 112 while observing the display 12, the selected image data 301 is read into the RAM 14, and the display controller 201 displays the target image on the display 12 based on the image data 301 (step S11).

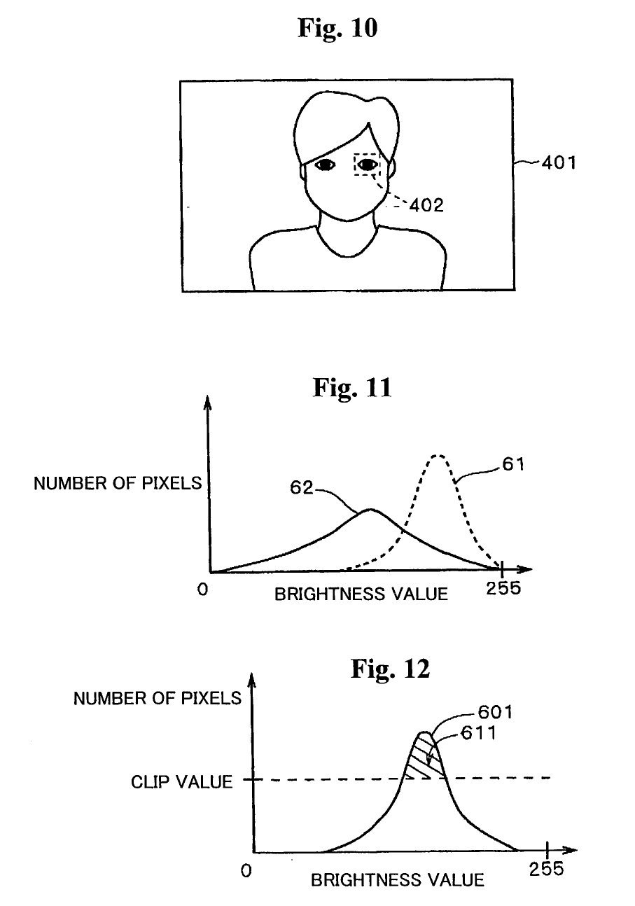

When the user uses the mouse 112 to designate a target region as an area requiring red-eye correction, the target region determining unit 202 determines a target region that will comprise the object for processing (step S12). Specifically, as shown in FIG. 10, a rectangular target region 402 that includes a red-eye region corresponding to one eye is determined when the user designates two diagonal points of the target region 402 in the target image 401.

Once a target region 402 is determined, the characteristic region extracting unit 204 converts the RGB values of each pixel of the target region 402 into a color space in the L*a*b* color system. Furthermore, the L*a*b* values are converted into hue, saturation and brightness, and these are obtained as the characteristic levels for each pixel (step S13).

The characteristic region extracting unit 204 then causes the contrast correction unit 207 to perform contrast correction of the target region 402 before extracting characteristic regions based on these characteristic levels (step S14). The target image 401 may be an image having clear bright and dark areas or an image in which there is minimal difference between the bright and dark areas and the brightness distribution is uneven, depending on the photography conditions. In images that include the red-eye phenomenon in particular, the brightness distribution often tends to concentrate in the higher brightness range, because photography was carried out using a flash. Consequently, by performing contrast correction, characteristic region extraction can be carried out based on the identical brightness standard regardless the type of the target image 401.

An example of the contrast correction routine performed by the contrast correction unit 207 will now be explained. A histogram that shows the relationship between each brightness value and the number of pixels in the target region 402 is first created by the contrast correction unit 207. FIG. 11 is an example of the histogram that may be obtained from the target region 402. In this embodiment, the minimum brightness value is deemed 0 and the maximum value is deemed 255.

Where the brightness distribution is spread from the minimum value to the maximum value as indicated by the number 62 in FIG. 11, the image has clear bright and dark areas. However, where the brightness distribution is concentrated in the high brightness range, as shown by the number 61 in FIG. 11, the image is a light-colored image as a whole, and the brightness characteristics are not clear. Therefore, it is difficult to apply the same brightness standard to the images indicated by the numbers 62 and 61. In addition, erroneous characteristic regions may result if the same brightness standard is used with these images. Therefore, the contrast correction unit 207 performs contrast correction on the target region 402 when the brightness distribution of the target image 401 is uneven.

Where the brightness distribution is uneven, the contrast correction unit 207 deforms the distribution such that the newly created histogram will have a range spreading from the maximum value to the minimum value. FIG. 12 is an example of the histogram 601 that may be obtained from the target region 402, and FIG. 13 shows a histogram 602 obtained by deforming the histogram 601 shown in FIG. 12.

The shaded regions 612 in FIG. 13 have the same area as the region above the clip value shown in FIG. 12. In other words, the histogram 602 shown in FIG. 13 is created by deleting the region 611 from the histogram 601 shown in FIG. 12 and adding the regions 612. Consequently, the number of pixels in the brightness range in which the number of pixels originally exceeds the clip value is reduced, and a histogram ranging from the maximum value to the minimum value is created.

The contrast correction unit 207 then generates a cumulative curve 620 for the histogram 602, as shown in FIG. 14. In FIG. 14, by having the horizontal axis represent the input brightness from 0 to 255 and having the vertical axis represent the output brightness from 0 to 255 , the cumulative curve 620 is used as a conversion curve that converts the brightness of each pixel of the target region 402. The contrast correction unit 207 performs brightness conversion, i.e., contrast correction, for the entire target region 402 by converting the brightness of a given pixel in the target region 402 using the cumulative curve 620 while sequentially moving from one pixel to another.

Through this processing, the unevenness in the brightness distribution of the target region 402 is corrected, and it becomes possible to extract characteristic regions using the same brightness standard regardless of the brightness distribution of the target image 401, as well as to precisely and appropriately extract characteristic regions without being influenced by the photography conditions for individual target images 401.

The characteristic region extracting unit 204 then extracts pupil regions, iris regions and iris periphery regions as characteristic regions from the target region 402 based on the characteristic levels of each pixel of the target region 402. Specifically, a region having a saturation and brightness that fall within a certain range (a region having both a saturation and a brightness that each fall within a low range) is extracted as a pupil region, and a region having a hue and a saturation that each fall within a certain range (a region in which the hue ranges from red to yellowish, and the saturation is in the high range) is extracted as an iris region. Furthermore, a region that has the same brightness range as the pupil region and the same hue range as the iris range is extracted as an iris periphery region (step S15).

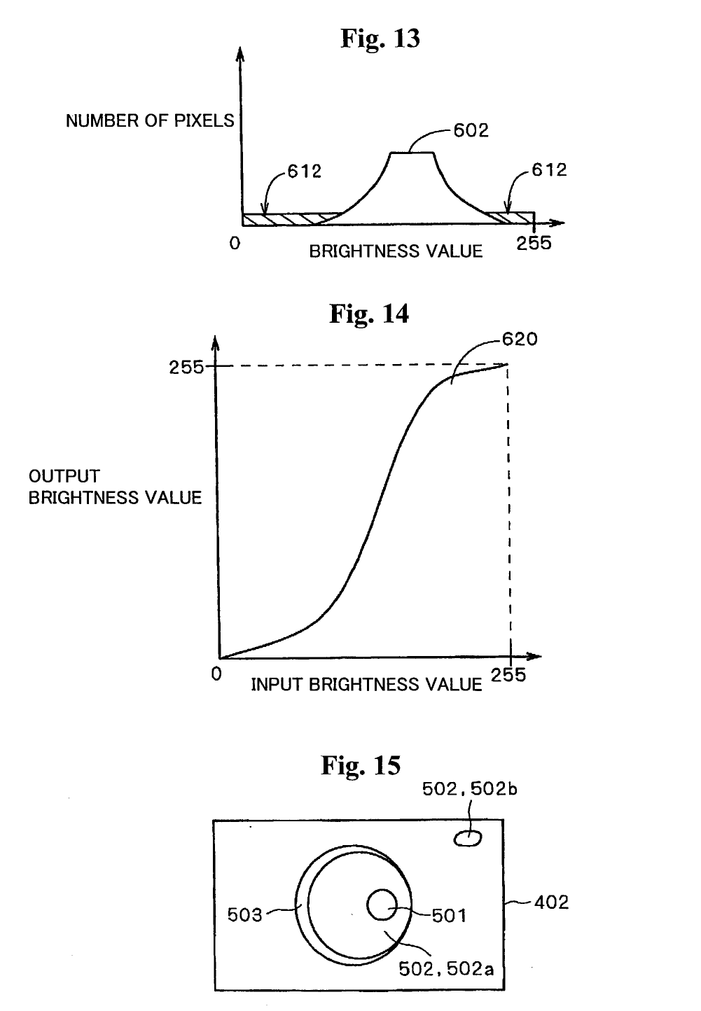

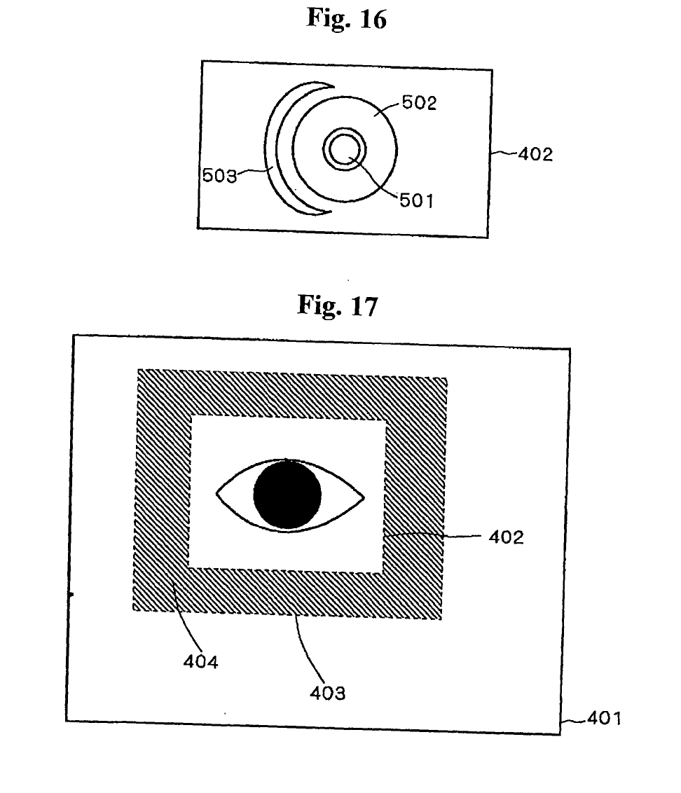

FIGS. 15 and 16 each show an example of the characteristic regions that may be extracted from the target region 402 by the characteristic region extracting unit 204. The number 501 indicates a pupil region, the numbers 502 (502a and 502b) indicate an iris region, and the number 503 indicates an iris periphery region. Depending on the red-eye condition, each type of characteristic region may not be extracted at all or multiple such regions may be extracted.

The ranges for the characteristic levels used for the extraction of the various types of characteristic regions are not determined from the characteristic levels obtained from a normal image that does not include the red-eye phenomenon, but are established statistically from the characteristic levels obtained from images having the red-eye phenomenon. Therefore, characteristic regions that have such characteristic levels are regions in which the red-eye phenomenon may be present, or in other words, such regions are extracted as candidate red-eye regions. Conversely, areas that were not extracted as any of the types of characteristic regions are areas that were determined to be areas that do not require red-eye correction.

Because a characteristic region is extracted as a pupil region 501, iris region 502 or iris, periphery region 503 based on at least two types of characteristic levels from among hue, saturation and brightness calculated from the pixel values of the target region 402, in comparison with extraction based on one type of characteristic level, the process is less affected by the target image 401 photography conditions, such that identification of characteristic regions can be carried out with increased precision.

The extracted characteristic regions are determined by the characteristic region extracting unit 204 as having hue, saturation or brightness characteristic levels falling within certain ranges. As a result, the extracted characteristic regions may include non-eye regions. Therefore, in the subsequent processing, the characteristic region sorting unit 208 sorts the extracted characteristic regions, and the red-eye region identification unit 205 identifies a red-eye region from among the sorted characteristic regions.

Where a characteristic region is not an eye region, it is very likely that the region is a person's skin. Therefore, the characteristic region sorting unit 208 sorts the characteristic regions by determining whether the hue of the pixels included in a characteristic region matches the skin color hue, and where pixels that match the skin color hue are included, that characteristic region is excluded as a candidate red-eye region. Because the skin color hue varies from one person to another, the skin color hue is obtained from a skin color area of the target image. The routine by which the characteristic region sorting unit 208 sorts the characteristic regions will be explained below.

A skin color retrieval region by which to obtain the skin color hue is first established by the skin color retrieval region establishing unit 211 (step S21 in FIG. 7). FIG. 17 is an example of a skin color retrieval region 404 thus established. Because the target region 402 is designated such that its frame surrounds one eye, it can be safely assumed that the area immediately outside the target region 402 is the person's skin area. Therefore, the region surrounding the frame of the target region 402 can be established as a skin color retrieval region. Specifically, as shown in FIG. 17, an expanded area (hereinafter ‘expanded target region’) 403 that has the same center of gravity and vertical/horizontal edge ratio as the target region 402 is first established, and the shaded area 404 located between the frame of the target region 402 and the frame of the expanded target region 403 is established as the skin color retrieval region 404.

The size Wr of the expanded target region 403 is given by the following function Fr based on the size S1 of the target region 402 and the size S2 of the target image 401. For the sizes S1 and S2 of these areas, the number of pixels may be used.

Wr=Fr(S1, S2) (a)

The function Fr is a function that increases the size Wr of the expanded target region 403 that is output as the size S1 of the target region 402 increases relative to the size S2 of the target image 401. For example, the above expression (a) can be expressed by the following expression (b). In the expression (b), k is a constant.

Wr=(S1/S2)k (b)

Because the target region 402 is designated such that it surrounds one eye, as described above, if the size S1 of the target region 402 relative to the size S2 of the target image 401 is large, it can be easily anticipated that the area that comprises the person's face in the target image 401, i.e., the area from which the skin color hue can be obtained, is also large. Therefore, by using the above function Fr, the larger the size S1 is relative to the size S2, the larger the size of the skin color retrieval region 404 becomes. Consequently, the hue can be obtained from pixels of the largest possible area in the subsequent processing such that a more precise skin color hue can be obtained.

Subsequently, the hue of each pixel included in the skin color retrieval region 404 is obtained by the skin color information obtaining unit 212. The numbers of pixels for each hue obtained are compared, and the hue for which there was the largest number of pixels is established as the skin color hue (step S22).

One characteristic region is then determined by the characteristic region excluding unit 213 as an object for processing (hereinafter a ‘subject characteristic region’) (step S23). The hue of the pixels included in the subject characteristic region is obtained, and it is determined by the characteristic region excluding unit 213 whether this hue matches the skin color hue (step S24). If they match, the subject characteristic region is excluded as a characteristic region comprising a candidate red-eye region (step S25).

When the determination regarding the pixel hue of one subject characteristic region is completed, the next subject characteristic region is selected (steps S26 and S23), and determination regarding the pixel hue takes place once more. The same operations are followed thereafter, and ultimately pixel hue determination is performed for all characteristic regions.

Through this processing, even if a person's skin area is extracted as a characteristic region, it can be excluded as a candidate red-eye region. Through this processing, characteristic regions are sorted, and as a result, the precision with which red-eye regions are identified may be improved.

The red-eye region identification unit 205 then performs operations by which to identify a red-eye region from among the characteristic regions selected by the characteristic region sorting unit 208. The routine performed by the red-eye region identification unit 205 to identify a red-eye region will now be explained.

First, one iris region 502 is determined by the contact relationship detecting unit 221 as an object for processing (hereinafter a ‘subject iris region’) (step S31). The contact relationship, i.e., whether or not the subject iris region is in contact with a pupil region 501 or an iris periphery region 503, is then determined (step S32). Where the subject iris region is in contact with one or both of these areas, the identification unit 224 establishes the subject iris region and the pupil region 501 and/or the iris periphery region 503 that are in contact with the subject iris region as a single area that comprises an object for subsequent processing as a candidate red-eye region (hereinafter a ‘candidate red-eye region’) (step S33).

When the determination as to the contact relationship of one subject iris region is completed, the next subject iris region is selected (steps S34 and S31), and a contact relationship determination is performed once more. These operations are thereafter performed until contact relationships have been determined for all iris regions.

Generally, as a characteristic of the red-eye phenomenon, red-eye regions are not scattered across the image, but are located near an iris region 502 and its surrounding area. Therefore, an iris region 502 and another characteristic region that is in contact with the iris region 502 are deemed to comprise a single candidate red-eye region, and an iris region 502 that is not in contact with any other characteristic region is not deemed a candidate red-eye regions.

For example, the iris region 502b shown in FIG. 15 and the iris region 502 shown in FIG. 16 are not in contact with the pupil region 501 or the iris periphery region 503 (in FIG. 16, the areas surrounding the pupil region 501 and iris periphery region 503 do not comprise characteristic regions), and therefore, it is likely that these are not eye regions or that the red-eye phenomenon is not taking place therein. Consequently, these iris regions 502 are not deemed candidate red-eye regions. On the other hand, because the iris region 502a shown in FIG. 15 is in contact with the pupil region 501 and the iris periphery region 503, it is likely that the red-eye phenomenon is taking place therein. Consequently, the area that includes the iris region 502a, pupil region 501 and iris periphery region 503 is deemed a candidate red-eye region. By establishing candidate red-eye regions based on the contact relationship between an iris region 502 and other characteristic regions in this way, a red-eye region can be appropriately identified as a result.

The identification unit 224 calculates a value that represents the red-eye likelihood of each candidate red-eye region as a red-eye evaluation value W in order to identify one red-eye region from among the multiple candidate red-eye regions established as described above, and identifies the candidate red-eye region that has the largest red-eye evaluation value W as a red-eye region.

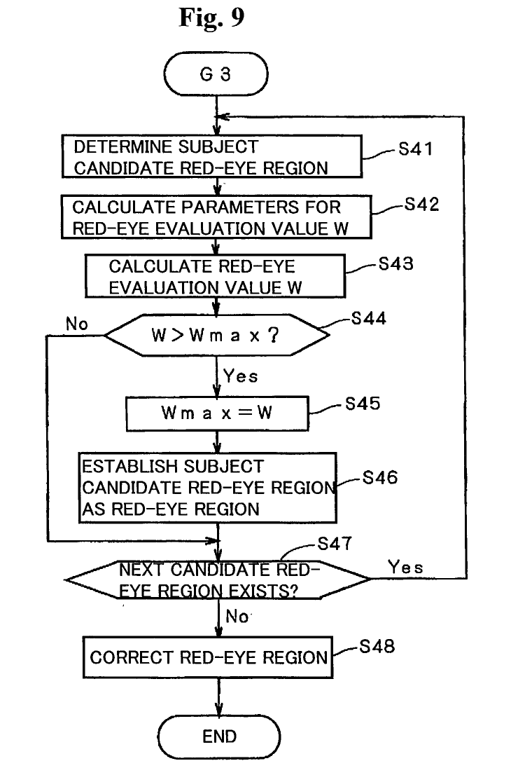

The identification unit 224 first determines one candidate red-eye region as an object for processing (hereinafter a ‘subject candidate red-eye region’)(step S41 in FIG. 9). The tone characteristics obtaining unit 222 and the area information obtaining unit 223 then calculate parameters for the red-eye evaluation value W of the subject candidate red-eye region (step S42).

FIG. 18 is a drawing showing the sequence of the red-eye evaluation value W parameter calculation routine. The tone characteristics obtaining unit 222 first creates a histogram that shows the relationship between each hue value and the number of pixels in the iris region 502 included in the subject candidate red-eye region. Similarly, a histogram that shows the relationship between each saturation value and the number of pixels in the iris region 502 included in the subject candidate red-eye region is created (step S101). From the hue histogram and the saturation histogram thus created, a hue distribution VH and a saturation distribution VS are calculated as red-eye evaluation value W parameters (step S102). In other words, hue and saturation distributions VH and VS are sought as tone characteristics of the subject candidate red-eye region.

The area information obtaining unit 223 then seeks the area AS of the subject candidate red-eye region as a red-eye evaluation value W parameter (step S103). For the area AS, the number of pixels of the entire subject candidate red-eye region is used. Because the candidate red-eye region includes an iris region 502 as well as a pupil region 501 and an iris periphery region 503 that are in contact with the iris region 502, as described above, the area resulting from adding together the areas of these regions is obtained as the area AS.

Once red-eye evaluation value W parameters are calculated in this way, the red-eye evaluation value W for the subject candidate red-eye region is sought via the following function Fa (step S43).

W=Fa(VH, VS, AS) (c)

The function Fa has the characteristics that as the hue distribution VH becomes smaller, as the saturation distribution VS becomes larger, and as the area AS becomes larger, the output red-eye evaluation value W becomes larger.

In general, because, as a characteristic of the red-eye phenomenon, colors other than red (the red eye hue) are seldom included in a red-eye region and the range of hue is small, the smaller the hue distribution VH, the larger the possibility that the subject region is a red-eye region. In addition, because a red-eye region often exhibits a bright red, as the saturation distribution VS increases, it becomes more likely that the subject region is a red-eye region. Furthermore, because the target region 402 is established such that it at least includes a region in which the red-eye phenomenon is present, as the area AS increases in size, it becomes more likely that the subject area is a red-eye region. Therefore, the higher the red-eye evaluation value W calculated using the above function Fa, the more likely that the candidate red-eye region is a red-eye region.

The calculated red-eye evaluation value W is then compared with the maximum value Wmax (step S44), and where the calculated red-eye evaluation value W is larger than the maximum value Wmax, the red-eye evaluation value W is established as a new maximum value Wmax (step S45). The subject candidate red-eye region is then established as a red-eye region (more precisely, as an area that has the highest probability of being a red-eye region at the time of processing)(step S46). With a first subject candidate red-eye region, step S44 is not performed, and steps S45 and S46 are always carried out.

When the calculation of the red-eye evaluation value W for one subject candidate red-eye region is completed, the next subject candidate red-eye region is selected (steps S47 and S41), and red-eye evaluation value W calculation and comparison with the maximum value Wmax are performed once more. The same operations are performed thereafter until red-eye evaluation values W for all candidate red-eye regions have been calculated, and the candidate red-eye region having the largest red-eye evaluation value W is ultimately identified as a red-eye region. In other words, through comparison of the red-eye evaluation values W, one red-eye region is identified.

When a red-eye region is identified, a routine by which to replace the color of the red-eye region with a prescribed color that resembles the pupil is performed by the correcting unit 206 such that the red color is corrected to a normal eye color. The post-correction data is synthesized with the image data 301 for areas other than the target region 402 to create corrected image data 302 (step S48). An identifier that indicates that the data is corrected may be added to the corrected image data 302 thus generated.

2. Second Embodiment

A second embodiment of the present invention will be explained below. The construction of the image processing apparatus of this embodiment is the same as that of the image processing apparatus 1 shown in FIGS. 1 through 5. The operations of the image processing apparatus 1 of this embodiment when it identifies a red-eye region and performs correction are also the same as those shown in FIGS. 6 through 9, except that only the calculation method regarding the red-eye evaluation value W for a candidate red-eye region is different. Therefore, the red-eye evaluation value W calculation routine is explained below.

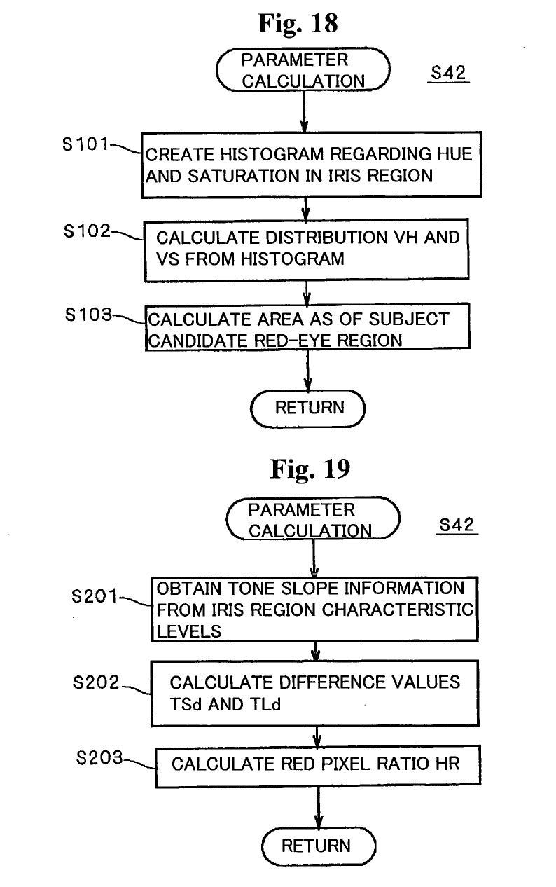

FIG. 19 is a drawing showing the sequence of the red-eye evaluation value W parameters calculation routine (step S42 in FIG. 9) of this embodiment. First, the tone characteristics obtaining unit 222 obtains tone slope information from the positional continuity of the characteristic levels of the iris region 502 included in the subject candidate red-eye region (step S201).

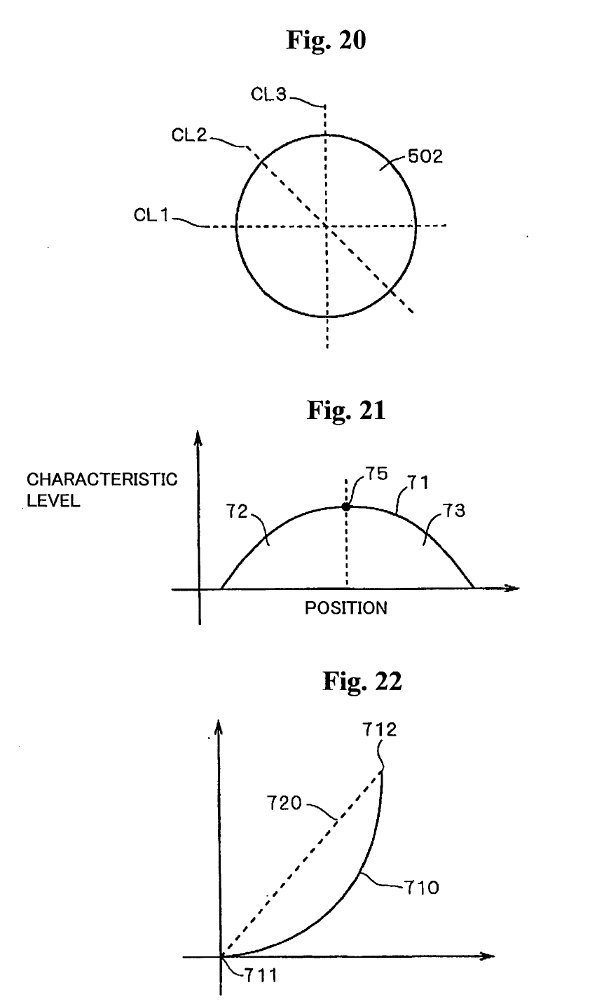

Specifically, three cutting lines CL1 through CL3 are first drawn on the iris region 502, as shown in FIG. 20, and graphs showing the characteristic level values (saturation and brightness) on these cutting lines are generated. FIG. 21 is a drawing showing an example of a characteristic level graph 71 regarding one cutting line. The horizontal axis represents the position on the cutting line and the vertical axis represents the characteristic level value. Once a graph 71 is generated as shown, it is divided into two regions 72 and 73 at a position 75 at which the characteristic level value is the largest, and deeming each graph portion 72 and 73 to comprise a histogram, a cumulative curve is generated as shown in FIG. 22. Also as shown in FIG. 22, a basic line 720 that connects the smallest value 711 and the largest value 712 of the generated cumulative curve 710 is drawn, coordinate conversion is performed such that the basic line 720 matches the horizontal axis, and a tone evaluation curve is thereby obtained.

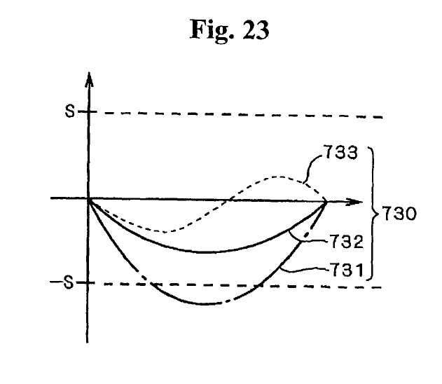

FIG. 23 is a drawing showing an example of the tone evaluation curve 730 obtained through the above processing. The tone evaluation curve 730 shows the positional change characteristics of the tone on the cutting line of the iris region 502. For example, where some of its values have an absolute value larger than a prescribed value S, as in the case of the curve 731, it can be determined that a region in which the tone suddenly changes exists in the iris region 502. Where the curve crosses the horizontal axis, as in the case of the curve 733 (or where the value changes from positive to negative or vice versa), it can be determined that a region in which the tone changes significantly exists in the iris region 502.

In general, the saturation and brightness of the iris region 502 in which the red-eye phenomenon is present has a smooth tone change (gradation) that is continuous from one position to another. Therefore, if the tone evaluation curve 730 of the iris region 502 is similar to the curve 731 or the curve 733, it does not qualify as a red-eye region. On the other hand, where there is no crossing with the horizontal axis and the absolute value is smaller than the prescribed value S at all times, as in the case of the curve 732, it is seen that the iris region 502 does exhibit the characteristics of a red-eye region.

Therefore, where the tone evaluation curve 730 looks like the curve 732, the largest absolute value on the curve is obtained as the tone slope value T, and where the tone evaluation curve 730 looks like the curve 731 or 733, the tone slope value T is deemed the default value (such as 0). For the prescribed value S, a value that is statistically sought in advance is used.

Because a tone slope value T is obtained with regard to each of the two graph 71 portions of the three cutting lines, a total of six tone slope values T are obtained. The tone characteristics obtaining unit 222 obtains the largest value among these six tone slope values T as the tone slope information. Because this tone slope information is obtained with regard to both saturation and brightness, saturation tone slope information TS and brightness tone slope information TL are ultimately obtained.

The ideal tone slope information values when the red-eye phenomenon is present in an iris region 502 are compared with the obtained tone slope information TS and TL, respectively, in order to seek differences from the ideal values (step S202 in FIG. 19). Specifically, the saturation difference value TSd and brightness difference value TLd are sought by the tone characteristics obtaining unit 222 using the following expressions (d) and (e).

TSd=|TS−TS0| (d)

TLd=|TL−TL0| (e)

TS0 and TL0 comprise the ideal saturation and brightness tone slope information values, respectively, and are statistically sought in advance. The calculated difference values TSd and TLd are used as red-eye evaluation value W parameters in the operations described below.

The area information obtaining unit 223 then seeks the ratio of the area of red pixels in the subject candidate red-eye region (hereinafter the ‘red pixel ratio’) HR as a red-eye evaluation value W parameter (step S203). Specifically, the hue of each pixel included in the subject candidate red-eye region is obtained, and the number of red pixels that have the ideal hue value when the red-eye phenomenon is present is calculated. The ideal hue value when the red-eye phenomenon is present is statistically sought in advance. The number of pixels (i.e., the area) of the entire subject candidate red-eye region is then sought, and the number of the red pixels relative to the number of pixels of the subject candidate red-eye regions is sought as the red pixel ratio HR. In other words, the red pixel ratio HR serves as information regarding the area of the subject candidate red-eye region.

Once the red-eye evaluation value W parameters have been calculated in this way, the red-eye evaluation value W for the subject candidate red-eye region is sought using the function Fb shown below (step S43 in FIG. 9).

W=Fb(TSd, TLd, HR) (f)

The function Fb has the characteristics that as the saturation difference value TSd becomes smaller, as the brightness difference value TLd becomes smaller, and as the red pixel ratio HR becomes larger, the output red-eye evaluation value W becomes larger. In other words, as the subject candidate red-eye region approaches an ideal red-eye region, the output red-eye evaluation value W increases. In short, a candidate red-eye region that has a larger red-eye evaluation value W that is calculated using the above function Fb is more likely to be a red-eye region. Consequently, by comparing red-eye evaluation values W, a red-eye region can be identified in this embodiment as well.

3. Modifications

The present invention is not limited to the embodiments described above and may be implemented in various modifications.

For example, in the above embodiments, the area between the target region 402 and the expanded target region 403 was deemed the skin color retrieval region, but because the frame of the target region 402 can be safely presumed to be a person's skin area, this frame only can be used as the skin color retrieval region.

In the above embodiments, a method to use the brightness cumulative histogram as a conversion curve was employed as the contrast correction method, but other approaches may be used, such as a method in which a pre-established conversion curve is selected based on the average brightness. In addition, contrast correction was carried out only with regard to the target region 402, but it can be performed regarding the entire target image 401.

Furthermore, in the above embodiments, a method in which the color of the red-eye region is replaced by a prescribed color that resembles the pupil color was used as the red-eye region correction method, but the correction method is not limited to the above implementation. For example, because the red-eye phenomenon occurs due to the fact that the pupil is emphasized to a bright red, correction may be made by reducing the R value among the RGB pixel values or by reducing the brightness.

In order to incorporate image data into the image processing apparatus 1, instead of reading it from a memory card 92 as in the above embodiments, image data may be obtained via signal transmission and receipt between the image processing apparatus 1 and another device through a cable connection or a communication circuit, or through wireless communication. The image data may be obtained through an imaging unit included in the image processing apparatus 1.

In the image processing apparatus 1, the series of image processing operations was carried out via software processing by the CPU, but such processing may alternatively be realized in whole or in part using dedicated circuits. In particular, if iterative operations are performed by a logic circuit, speedy image processing can be achieved.

In the above embodiments, the configuration of the target region 402 was rectangular, but this configuration is not essential. For example, the target region may have oval configuration or any other configuration designated by the user. Moreover, in the above embodiments, a target region 402 was designated by the user, but it can be automatically designated based on determination via image recognition or the characteristic levels.

In the above embodiments, hue, saturation and brightness were used as the characteristic levels, but values in such color systems as L*a*b*, LUV or XYZ may be used as the characteristic levels, or the RGB values may be used as the characteristic levels as is.

What is claimed is:

1. A computer program that causes a computer to function as an image processing apparatus comprising:
a characteristic region extracting unit for, based on characteristic levels of a target region encompassing an eye region of a target image, extracting from the target region as candidate red-eye regions multiple characteristic regions that include iris regions; and
a red-eye region identification unit for identifying a red-eye region based on existence of contact between the iris regions and other characteristic regions, tone characteristics regarding characteristic levels of each characteristic region, and area information regarding areas of each characteristic region.

2. A computer program as claimed in claim 1, wherein the characteristic region extracting unit extracts the characteristic regions based on characteristic levels for at least two types of characteristics from among hue, saturation and brightness, which are calculated from pixel values of the target region.

3. A computer program as claimed in claim 1, wherein the characteristic regions include, in addition to the iris regions, pupil regions and iris periphery regions, the iris region being a region having a hue and saturation that fall within prescribed ranges, the pupil region being a region having a saturation and brightness that fall within prescribed ranges, and the iris periphery region being a region having the same hue range as the iris region and the same brightness range as the pupil region.

4. A computer program as claimed in claim 1, wherein, where the iris region is in contact with another characteristic region, the red-eye region identification unit establishes as a candidate red-eye region the entire region consisting of the iris region and the the characteristic region that is in contact with the iris region, but where the iris region is not in contact with any other characteristic regions, the iris region is excluded as a candidate red-eye region.

5. A computer program as claimed in claim 4, wherein the red-eye region identification unit identifies one of the region established as candidate red-eye regions as a red-eye region based on evaluation values calculated from the tone characteristics and the area information.

6. A computer program as claimed in claim 1, wherein the area information consist of information regarding an area comprising the sum of an area of the iris region and an area of the other characteristic region that is in contact with the iris region.

7. A computer program as, claimed in claim 1, wherein the tone characteristics include values calculated from histograms regarding the characteristic levels for the iris region.

8. A computer program as claimed in claim 1, wherein the tone characteristics include values calculated from the positional continuity of the characteristic levels for the iris region.

9. A computer, program as claimed in claim 1, wherein the image processing apparatus further comprises:
a skin color information obtaining unit for obtaining skin color information from colors of pixels in an area surrounding the target region; and
a characteristic region excluding unit for, where color of pixels included in the characteristic region matches the skin color information, excluding the characteristic region as a candidate red-eye region.

10. A computer program as claimed in claim 9, wherein the image processing apparatus further comprises a skin color retrieval region establishing unit for establishing a size of the surrounding area by which to obtain the skin color information, based on a size of the target image and a size of the target region.

11. A computer readable recording medium that stores therein a computer program as claimed in claim 1.

12. A computer program that causes a computer to function as an image processing apparatus comprising:
a characteristic region extracting unit for, based on characteristic levels regarding a target region encompassing an eye region in a target image, extracting as candidate red-eye regions from the target region multiple characteristic regions that include iris regions;
a contact relationship detecting unit for determining whether each iris region is in contact with another characteristic region; and
a red-eye region identification unit for, where the contact relationship detecting unit determines that the iris region is in contact with another characteristic region, establishing the entire region comprising the iris region and the characteristic region as a candidate red-eye region, and identifying one of the regions thus established as a red-eye region.

13. A computer readable recording medium that stores therein a computer program as claimed in claim 12.

14. An image processing apparatus comprising:
a characteristic region extracting unit for, based on characteristic levels regarding a target region encompassing an eye region in a target image, extracting as candidate red-eye regions from the target region multiple characteristic regions that include iris regions; and
a red-eye region identification unit for identifying a red-eye region based on existence of contact between the iris regions and other characteristic regions, tone characteristics regarding characteristic levels of each characteristic region, and area information regarding areas of each characteristic region.

15. An image processing method comprising the steps of:
extracting as candidate red-eye regions, based on the characteristic levels for a target region encompassing an eye region in the target image, multiple characteristic regions that include iris regions from the target region; and
identifying a red-eye region based on existence of contact between the iris regions and other characteristic regions, tone characteristics regarding characteristic levels of each characteristic region, and area information regarding areas of each characteristic region.
